(19) United States
(12) Patent Application Publication
(10) Pub. No.: US 2024/0241842 A1
(43) Pub. Date: Jul. 18, 2024

(54) ACCELERATED DRAM (DYNAMIC RANDOM ACCESS MEMORY) TRAINING

(71) Applicant: Intel Corporation, Santa Clara, CA (US)

(72) Inventors: Saravanan SETHURAMAN, Portland, OR (US); Tonia M. ROSE, Wendell, NC (US); Caroline GRIMES, Raleigh, NC (US)

(21) Appl. No.: 18/622,902

(22) Filed: Mar. 30, 2024

(51) Int. Cl. G06F 13/16; G06F 9/30; G06F 13/42

(52) U.S. Cl. CPC G06F 13/1668; G06F 9/30189; G06F 13/4243

(57) ABSTRACT

Training a physical interface between a memory device and a memory controller can be performed with an autonomous sweep. The sweep can occur without commands from the host to trigger each parameter sweep. With a two dimensional sweep, instead of interrupting a training mode for a first parameter to sweep a second parameter, circuitry in the memory can automatically sweep the second parameter in the training mode for the first parameter.

### TECHNICAL FIELD

Descriptions are generally related to computer memory, and more particular descriptions are related to memory interface training.

### BACKGROUND OF THE INVENTION

With increasing memory subsystem I/O (input/output) speeds and lower power operation, the margins for the signals on the buses (e.g., CA (command/address) bus, DQ (data) bus) become finer. The system trains the I/O to set the configuration parameters needed to achieve the I/O margins. Upcoming memory devices can have dozens (e.g., 50+) training steps to perform on system boot to train the I/O interface with proper margins for high-speed command and data transfer.

Many of the training steps involve sweeping parameters to determine which of many possible settings provides the best signal performance. Signal performance can be understood in terms of having bit error rates within acceptable bounds. The sweep for each parameter has been controlled by the use of a command from the host to the memory device to place the memory device in the appropriate training mode to sweep the parameter. However, many parameters are dependent on others, which has resulted in the system sending commands to interrupt one training mode to set different values for a different parameter to determine the best configuration.

Sending an MRW (mode register write) or MPC (multipurpose command) to trigger the memory device into a training mode, the more commands to change each parameter for a sweep is not efficient. The inefficiency increases when sweeping multiple parameters for a particular training. For example, if the training pattern type is Vref (voltage reference) and delay sweep, the system could stop the Vref training, issuing an MRW to change the Vref value, and then redo the delay sweep to determine eye margin for the particular Vref setting with each delay setting. The training would perform the same operations for all the Vref values, sweeping the delay for each setting, interrupting the training each time to transition configuration parameters value. Each such operation increases the training time, which in turn increases the system boot time.

### BRIEF DESCRIPTION OF THE DRAWINGS

The following description includes discussion of figures having illustrations given by way of example of an implementation. The drawings should be understood by way of example, and not by way of limitation. As used herein, references to one or more examples are to be understood as describing a particular feature, structure, or characteristic included in at least one implementation of the invention. Phrases such as “in one example” or “in an alternative example” appearing herein provide examples of implementations of the invention, and do not necessarily all refer to the same implementation. However, they are also not necessarily mutually exclusive.

FIG. 1 is a block diagram of an example of a system that trains I/O for a memory die.

FIG. 2 is a block diagram of an example of a memory subsystem I/O.

FIG. 3A is a block diagram of an example of a system with a memory module with a memory device I/O trained by an autonomous sweep.

FIG. 3B is a block diagram of an example of a system with a memory module with a buffer device I/O trained by an autonomous sweep.

FIG. 4 is a block diagram of an example of a DIMM trained by an autonomous sweep.

FIG. 5A is a timing diagram example of prior art training sweep.

FIG. 5B-5C are timing diagram examples of autonomous training sweeps.

FIG. 6 is a flow diagram of an example of a process for memory training.

FIG. 7 is a block diagram of an example of a memory subsystem in which autonomous training sweeps can be implemented.

FIGS. 8A-8B are block diagrams of an example of a CAMM system in which autonomous training sweeps can be implemented.

FIG. 9 is a block diagram of an example of a computing system in which autonomous training sweeps can be implemented.

FIG. 10 is a block diagram of an example of a multi-node network in which autonomous training sweeps can be implemented.

Descriptions of certain details and implementations follow, including non-limiting descriptions of the figures, which may depict some or all examples, and well as other potential implementations.

### DETAILED DESCRIPTION OF THE INVENTION

As described herein, a system can train the physical interface of the memory device with an autonomous sweep performed by the memory device. The memory device can be, for example, a DRAM (dynamic random access memory) device. The sweep can occur without commands from the host (e.g., MRW (mode register write) or extended MPC (multipurpose command)) to trigger each parameter sweep. Sending an MRW or MPC command to change each parameter is inefficient, especially for training that sweeps multiple parameters.

A one dimensional (1D) sweep can refer to sweeping a parameter to test different configuration settings for a single parameter in a training mode. A two dimensional (2D) sweep can refer to sweeping a first parameter that is dependent on the configuration of a second parameter. For example, consider setting a delay configuration parameter, which can be dependent on the Vref (voltage reference) configuration parameter.

Instead of needing to break the delay training to change the Vref setting (e.g., testing the delay, stopping the delay testing to issue an MRW to change the Vref value, performing the delay sweep again, then changing to a new Vref value to repeat the delay sweep, and so forth). As described herein, the memory device can automatically sweep the parameter to find the margin. The host can continue to send write commands and read commands to issue the test pattern, however, the host does not need to send MRW or MPC commands to trigger the parameter sweep. Rather, the memory device can handle the parameter sweep based on the monitoring a transition trigger.

There can be dozens of training steps that use parameter sweeps to set margins for the CA (command/address) bus and for the DQ (data) bus communication. Autonomous sweeping at a DRAM device can speed up all training modes that sweep parameters. The time savings increase when multiple parameters are swept in the training mode. In systems having many channels of memory and many memory ranks (e.g., server systems), the autonomous sweeping described can save many seconds of boot time.

Newer DRAM devices sweep parameters to set DFE (decision feedback equalization) taps, DFE gain, Vref sweeps, CA settings, CS (chip select) settings, and other parameters ensure there are sufficient signaling margins on the command, address, and data pins. In one example, the system applies a training accelerator in the DRAM state machine that can automate the training sweeps. The DRAM can monitor for a trigger to determine when to transition a parameter to a subsequent value in the sweep. In one example, the DRAM counts CS assertions to determine when to transition parameter values. Another trigger example is an edge transition on a command signal line that the DRAM monitors.

The memory device includes in-built logic to perform the sweeps internally. As mentioned above, the memory device can have firmware support in the state machine. Additionally, the memory device can have accelerated hardware logic such as counters, registers, decision hardware, and other components to perform the sweeps internally. While mention is made specifically to logic in the memory device, in one example, another logic device can be included to perform the training sweeps. In one example, a DIMM (dual inline memory module) or other memory module (e.g., a CAMM (compression attached memory module)) having multiple DRAMs installed can have a logic die on the memory module to manage the internal sweeps for the training. In addition to the DRAM devices, a memory module with DBs (data buffers) can have logic in the DBs to perform the sweeps for the DB settings. Alternatively, a logic device on the memory module can manage the sweeps for the DBs.

In one example, after performing internal sweeping of the parameters, the memory device resets the parameters to the settings it had prior to the training mode. For example, the memory device can save a configuration state, and restore the state after training is complete. While the memory device can internally perform the training sweeps, the memory controller can still perform measurement of the training sweeps and compute an optimized configuration parameter (or configuration parameters). The memory controller can then ultimately set the configuration parameters for the memory device.

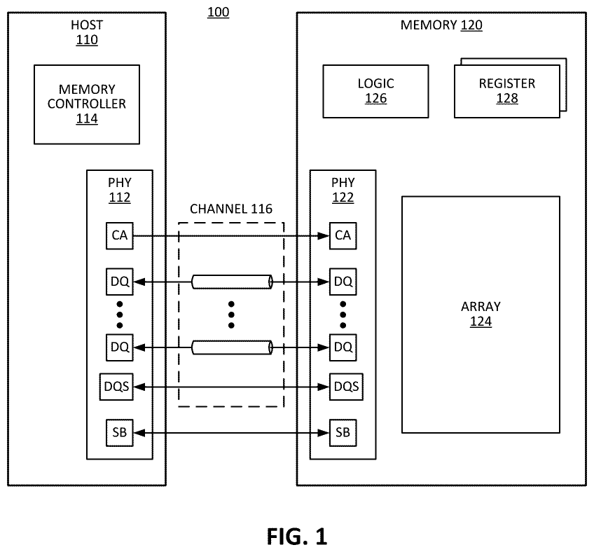

FIG. 1 is a block diagram of an example of a system that trains I/O for a memory die. System 100 includes host 110 coupled to memory 120 over a communication channel. Channel 116 represents a high-speed channel for HSIO (high speed input/output).

Host 110 represents a computer system platform, such as an SOC (system on a chip) having the processors, memory controller, and peripheral controllers. Memory 120 represents system memory for host 110, such as a DRAM device or memory module having multiple DRAM devices.

Host 110 includes PHY (physical interface) 112 and memory 120 includes PHY (physical interface) 122. PHY 112 and PHY 122 include DQ (data) signal line interfaces, coupled together through signal lines. DQ can represent an interface to the data bus. The number of DQ interfaces depends on the data bus for the system used, such as 4 signal lines, 8 signal lines, 10 signal lines, or some other number of data signal lines in the data bus.

PHY 112 and PHY 122 also illustrate CA (command/address) signal line interfaces, and SB (sideband) signal line interfaces. CA can represent an interface to the CA bus, and SB can represent an interface to the sideband bus. While there are multiple DQ interface illustrated for the DQ bus, it will be understood that the single line for the CA bus and the SB bus can also represent multiple signal lines. The command is typically multiple signal lines, and is a unidirectional bus from the sender to the receiver. DQS (data strobe) represents the data strobe signal line used to manage the timing of signal on the DQ bus.

The sideband line can be one or more signal lines for host 110 and memory 120 to communicate other information. One common use for a sideband channel is to allow a lower-speed communication path that can be used for auxiliary functions or to communicate prior to training the HSIO. Thus, in one example, the sideband channel is not part of channel 116. In one example, the sideband signal represents a signal line in the HSIO other than the CA bus and the DQ bus.

PHY 112 includes transmitter circuitry for the CA bus, receiver circuitry for one-way signals back from PHY 122 (not specifically illustrated), and transceiver circuitry for the data bus. PHY 122 includes receiver circuitry for the CA bus, transmitter circuitry for one-way signals to PHY 112, and transceiver circuitry for the data bus. To the extent that the sideband bus is separate from channel 116, the physical interfaces can include transceiver circuitry to enable communication over the sideband channel.

Host 110 includes memory controller 114, which represents a controller component that manages access to memory 120. Memory controller 114 can manage the configuration settings for channel 116 to ensure proper signal eyes.

Memory 120 includes array 124, which represents a memory array to store data for host 110. Register 128 represents one or more registers to store configuration information for memory 120. Register 128 can store I/O configuration parameters to control the signaling operation of PHY 122. In one example, register 128 is or includes mode registers for memory 120. Logic 126 represents in-built logic for memory 120 to manage training sweeps to train the I/O configuration parameters. The I/O configuration parameters trained by sweeping different settings can be parameters for the DQ bus, the CA bus, and the DQS signal.

To train the I/O interface of memory 120, memory controller 114 can generate and send a known data pattern over channel 116. In one example, memory controller 114 sends a sequence of write and read commands to send the data pattern to memory 120, and read the data back to ensure it was properly sent over channel 116. The training can shmoo the signals by adjusting various voltage levels or current levels or both current and voltage levels to test different parameters for the signaling. In general, the testing shmoos signal parameters to test the bit error rate at different parameter settings until the BER (bit error rate) is within an accepted range.

In one example, logic 126 can represent the state machine of memory 120, and specifically, the control that manages parameter sweeping internally within memory 120, without direct control over the parameter sweeps by explicit commands from memory controller 114. In one example, logic 126 represents an acceleration engine for internal parameter sweeps, to speed up the training of the physical interface.

In one example, to implement internal sweeps, memory 120 should include the following:
1) the ability to program a register with start and stop values;
2) hardware to enable programming the patterns (e.g., an LFSR (linear feedback shift register));
3) logic to trigger the transition to a subsequent value in the sweep; and
4) hardware to store original parameter values before performing training, and logic to reset the configuration parameters to the original values when training completes.

Even with a full implementation of the four items listed above, there is not a requirement for very much logic to implement the sweep accelerator. It is estimated that the logic needed would be <<1% overhead. Logic 126 can represent each of the items used to implement the sweep acceleration. In one example, logic 126 includes counters, trigger logic, and registers to configure the sweeps.

Even with memory 120 performing internal sweeps, memory 120 will send values to host 110 for memory controller 114 to compute and set the final configuration in memory 120. In one example, memory 120 sends all value to host 110 for the sweep information. In one example, memory 120 sends only selected values to host 110.

In one example, host 110 (e.g., via memory controller 114) sends an indication to memory 120 when a sweep is complete. In one example, memory controller 114 writes a flag or clears a flag (e.g., a bit or multiple bits) in a mode register to indicate that the sweep is complete. In one example, memory controller 114 sends an indication on an M3C (memory module management control) bus, which is an example of a sideband channel. In one example, system 100 uses M3C or another sideband channel during initial portions of the training because the primary channels are untrained, and would therefore not be reliable at high speed.

In one example, after setting memory 120 into a training mode, host 110 sends training patterns to memory 120 to implement the training, while memory 120 internally manages the transition of parameter sweeps. Memory 120 can monitor a trigger for sweep transitions. In one example, logic 126 counts CS assertions through the write and read commands of the training pattern to determine when to transition parameter values in the sweep.

In one example, system 100 is programmable for transition timing. In one example, different numbers of counts will trigger a transition in different training modes. In one example, register 128 includes a field to program how many CS signals or other signals should be counted before transitioning the sweep parameter value. Thus, the system can program different transitions for different training modes, for different memory devices, or for different implementations.

There are any number of use cases where memory 120 can apply internal parameter sweeping. The use cases include, but are not limited to: write leveling, receive enable training, DQ-DQS (data-data strobe) 2D Vref training, read DFE training, write DFE training, QCA (command/address signal line reference) training, QCS (chip select signal line reference) training, and ODT (on die termination) sweeps.

Reference is made herein to 1D sweeps and to 2D sweeps. In one example, the memory controller sets the memory in a training mode to sweep a parameter in a 1D training, and the memory can sweep the parameter internally. In one example, the memory controller sets the memory in a training mode to sweep two parameters in a 2D training. In one example, the memory sweeps both the first and the second parameters internally.

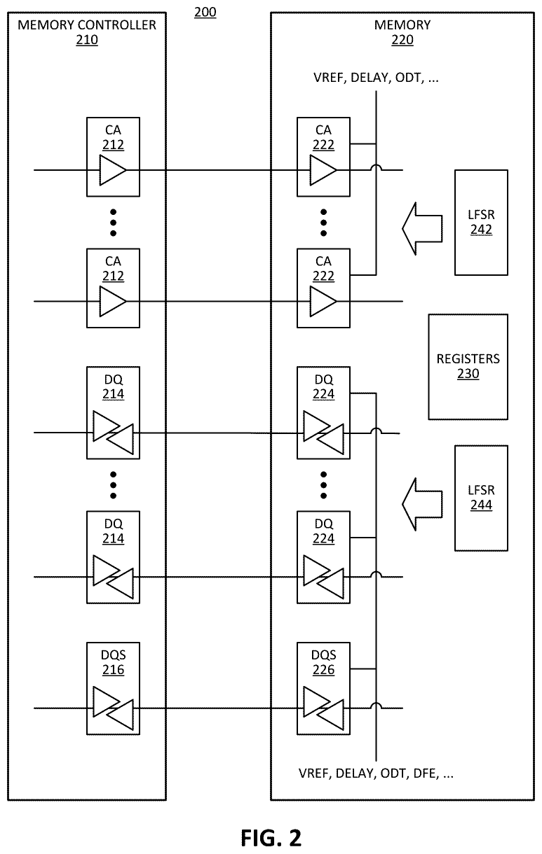

FIG. 2 is a block diagram of an example of a memory subsystem I/O. System 200 illustrates a memory subsystem in accordance with an example of system 100.

System 200 more specifically illustrates the host PHY components within memory controller 210, and the memory PHY components within memory 220. It will be understood that memory controller 210 can be a circuit on the processor die (e.g., an iMC (integrated memory controller)), in which case the memory controller and the PHY are circuits on the processor, where the PHY is the interface to memory 220. Additionally, in a memory module, there can be an RCD (registering clock driver), a data buffer, or other device between memory controller 210 and memory 220 on one or more signal lines. It will be understood that memory 220 will still need to configure its physical interface to communicate over the channels.

System 200 illustrates multiple CA interfaces 212 in memory controller 210, with drivers to indicate that the host drives the CA bus. System 200 illustrates corresponding CA interfaces 222 in memory 220 to receive the command information from the host or the RCD. It will be understood that there can be Vref, delay, ODT, or other parameters to configure the CA bus interface. While not specifically illustrated, in one example, the CA bus has DFE configuration as well as the DQ bus.

System 200 illustrates multiple DQ interfaces 214 in memory controller 210, with transceivers to indicate that the host drives data on the DQ bus for write operations and receives data on the DQ bus for read operations. System 200 illustrates corresponding DQ interfaces 224 in memory 220, with transceivers to indicate that the memory (or data buffer) drives data on the DQ bus for read operations and receives data on the DQ bus for write operations.

System 200 illustrates DQS interface 216 in memory controller 210, with transceivers to indicate that the host drives the DQS signal line for write operations and receives the DQS signal for read operations. System 200 illustrates DQS interface 226 in memory 220, with transceivers to indicate that the memory (or data buffer) drives the DQS signal line for read operations and receives the DQS signal for write operations. Essentially, the DQS signal follows the DQ bus direction. It will be understood that there can be Vref, delay, ODT, DFE, or other parameters to configure the DQ bus interface and the DQS interface.

The following are common training parameters where the system performs training sweeps to find margins.
DQVref values;
DRAM CAVref (QCA) in the case of UDIMM (unbuffered or unregistered DIMM), RDIMM (registered DIMM), or MRDIMM (multi-ranked buffered DIMM);
DRAM CSVref (QCS) in the case of UDIMM, RDIMM, or MRDIMM;
DFE tap settings (either DQ taps or CA taps);
DFE Gain Settings (either DQ taps or CA taps);
DRAM internal write leveling pulse sweep (WICA (write-leveling internal cycle alignment));
DRAM DQS (data strobe) offset; and
Termination settings sweep (ODT for DQ, CLK (clock), CA, CS).

Memory 220 includes registers 230, which represent registers to store configuration information for the various interfaces. Registers 230 can represent registers for CA configuration settings and for DQ configuration settings. In one example, memory 220 can sweep multiple configuration parameters together, such as a delay setting and a voltage reference setting.

System 200 illustrates LFSR (linear feedback shift register) 242 to provide sweep patterns to train CA configuration parameters, and LFSR 244 to provide sweep patterns to train DQ configuration parameters. In one example, LFSR 242 and LFSR 244 are reused for other purposes in memory 220. In one example, logic other than an LFSR can be used to generate sweep patterns, such as latches or other hardware.

In one example, LFSR 242 and LFSR 244 are 8-bit shift registers. In one example, LFSR 242 and LFSR 244 are 16-bit shift registers. Logic in memory 220 (not specifically illustrated in system 200) sets up the LFSRs and executes the training. In one example, there can be an LFSR per signal line. Thus, there could be an LFSR per signal line of the CA bus, and an LFSR per DQ.

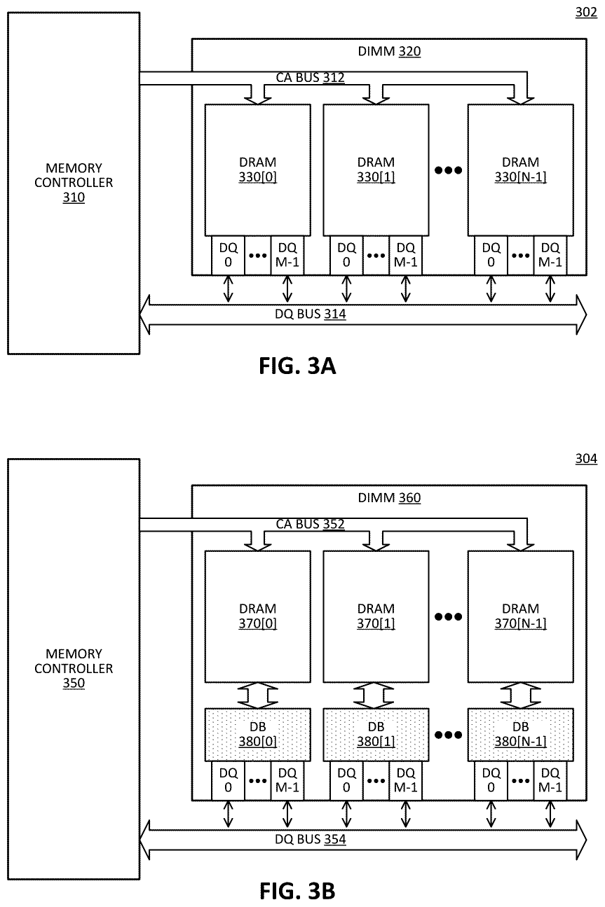

FIG. 3A is a block diagram of an example of a system with a memory module with a memory device I/O trained by an autonomous sweep. System 302 illustrates a memory subsystem in accordance with an example of system 100 or an example of system 200. System 302 includes memory controller 310 coupled to DIMM (dual inline memory module) 320. Memory controller 310 represents a controller of a CPU (central processing unit), GPU (graphics processing unit, or other processor. DIMM 320 includes multiple DRAM devices.

System 302 illustrates an example of a system with memory devices that share a control bus or command bus (CA (command/address) bus 312) and data bus (DQ bus 314). The memory devices are represented as DRAM (dynamic random access memory) devices. Each channel has N DRAM devices, DRAM 330[0:N−1] (collectively, DRAM devices 330), where N can be any integer. In one example, N includes one or more ECC (error checking and correction) DRAM devices in addition to the data devices. Each DRAM device 330 can represent a memory chip with a command bus interface to memory controller 310.

CA bus 312 is typically a unilateral bus or unidirectional bus to carry command and address information from memory controller 310 to DRAM devices 330. Thus, CA bus 312 can be a multi-drop bus. Data bus 314 is traditionally a bidirectional, point-to-point bus. System 302 illustrates M DQ signal line interfaces from each DRAM device 330 to DQ bus 314. The specific number of interfaces to CA bus 312 is not specifically illustrated.

System 302 can train the interface to DQ bus 314 with internal parameter sweeps by the DRAM devices, in accordance with any example described above. While the signal line interfaces to CA bus 312 are not specifically illustrated, it will be understood that the DRAM devices can likewise perform internal sweeps to train the parameters to configure the interface to the CA bus in accordance with any example described above.

FIG. 3B is a block diagram of an example of a system with a memory module with a buffer device I/O trained by an autonomous sweep. System 304 includes memory controller 350 coupled to DIMM 360. System 304 illustrates an example of a memory subsystem in accordance with an example of system 302. Memory controller 350 represents a controller of a CPU (central processing unit), GPU (graphics processing unit, or other processor. DIMM 360 includes multiple DRAM devices.

System 304 illustrates an example of a system with memory devices that share a control bus or command bus (CA (command/address) bus 352) and data bus (DQ bus 354). The memory devices are represented as DRAM (dynamic random access memory) devices. Each channel has N DRAM devices, DRAM 370[0:N−1] (collectively, DRAM devices 370), where N can be any integer. In one example, N includes one or more ECC (error checking and correction) DRAM devices in addition to the data devices. Each DRAM device 370 can represent a memory chip with a command bus interface to memory controller 350.

CA bus 352 is typically a unilateral bus or unidirectional bus to carry command and address information from memory controller 350 to DRAM devices 370. Thus, CA bus 352 can be a multi-drop bus. Data bus 354 is traditionally a bidirectional, point-to-point bus. System 304 illustrates M DQ signal line interfaces from each DRAM device 370 to DQ bus 354. The specific number of interfaces to CA bus 352 is not specifically illustrated.

System 304 can train the interface to DQ bus 354 with internal parameter sweeps by the DRAM devices, in accordance with any example described above. While the signal line interfaces to CA bus 352 are not specifically illustrated, it will be understood that the DRAM devices can likewise perform internal sweeps to train the parameters to configure the interface to the CA bus in accordance with any example described above.

In one example, DIMM includes DB (data buffer) 380[0:N−1] (collectively, data buffers 380) to buffer the connection of DRAM devices 370 with data bus 314. System 304 illustrates a one-to-one relationship between data buffers 380 and DRAM devices 370. In one example, there are fewer data buffers 380 than DRAM devices 370, with DRAM devices sharing a data buffer. System 304 can train the interfaces of data buffers 380 with internal configuration parameter sweeps in accordance with any example described above, where the data buffer is the memory device that has internal logic to implement the training sweep acceleration.

System 302 illustrates a DIMM without data buffers, while system 304 specifically illustrates data buffers. It will be understood that internal sweeping can work in DRAM devices in any type of DIMM. Additionally, the training sweep accelerator can be implemented in DRAM devices, as well as data buffer devices in a DIMM. Thus, the application of internal sweeps can be implemented in RDIMM systems (e.g., servers, desktops), UDIMM systems (e.g., client systems), and MCRDIMM (multiplexed combined ranks DIMM) and MRDIMM systems (e.g., systems with high memory capacity).

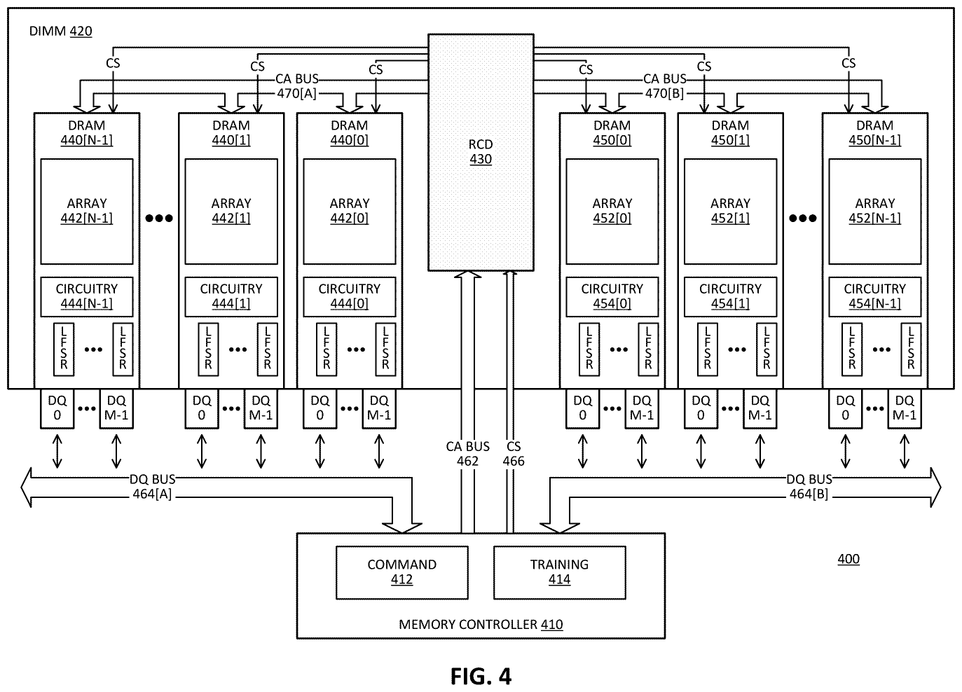

FIG. 4 is a block diagram of an example of a DIMM trained by an autonomous sweep. System 400 illustrates memory coupled to a host. System 400 illustrates a memory subsystem in accordance with an example of system 100, an example of system 200, an example of system 302, or an example of system 304. System 400 illustrates further details of the memory module.

DIMM 420 represents a memory module that includes multiple memory devices, DRAM devices 440[0:(N−1)], collectively DRAM devices 440 for channel A, and DRAM devices 450[0:(N−1)], collectively DRAM devices 450 for channel B. N can be any integer greater than 1. The DRAM devices can include data devices and ECC (error checking and correction) devices.

Memory controller 410 represents the host, which can be part of a computing platform, such as a CPU SOC or other host processing element SOC, such as a GPU. Memory controller 410 includes hardware interfaces to interconnect with DIMM 420. While DIMM 420 provides one example of a module with multiple memory devices, system 400 could alternatively be applied with an HBM (high bandwidth memory) package having multiple DRAM chips in a vertical stack, or with a different form of memory module, such as a CAMM.

System 400 illustrates one example of DIMM 420 with RCD 430 and memory devices. RCD 430 represents a controller for DIMM 420. In one example, RCD 430 receives information over CA bus 462 from memory controller 410 and buffers the signals to the memory devices over CA buses. CS 466 represents the chip select information for the commands on CA bus 462. System 400 represents two separate channels on DIMM 420, where each channel can have one or more ranks of DRAM devices. A rank refers to a group of DRAM devices that are accessed by a common CSA (chip select) signal.

CA bus 470[A] can be a first channel (Channel A) for DRAM devices 440. CA bus 470[B] can be a second channel (Channel B) for DRAM devices 450. System 400 also illustrates CS signals, which can select the individual DRAM devices. CA bus 470[A] and CA bus 470[B] can collectively be referred to as CA buses 470. CA buses 470 represent buses to provide command encoding and address information for a memory access operation.

DQ bus 464[A] represents a bus to exchange data between DRAM devices 440 and memory controller 410, and DQ bus 464[B] represents a bus to exchange data between DRAM devices 450 and memory controller 410. DQ bus 464[A] and DQ bus 464[B] can collectively be referred to as DQ buses 464. System 400 does not explicitly illustrate the DQS signal lines, but it will be understood that the DQ buses will have associated DQS signals to manage timing of the data signals.

DRAM devices 440[0:N−1] respectively include array 442[0:N−1], collectively arrays 442. Arrays 442 store data from DQ bus 464[A] in response to a write command, and provide data to DQ bus 464[A] in response to a read command. DRAM devices 440[0:N−1] respectively include circuitry 444[0:N−1], collectively circuitry 444. Circuitry 444 represents circuitry that interfaces arrays 442 to store data from DQ bus 464[A] in response to a write command, and provide data to DQ bus 464[A] in response to a read command. In one example, circuitry 444 enables DRAM devices 440 to perform internal training sweeps in accordance with any example described herein.

DRAM devices 450[0:N−1] respectively include array 452[0:N−1], collectively arrays 452. Arrays 452 store data from data bus 464[B] in response to a write command, and provide data to data bus 464[B] in response to a read command. DRAM devices 450[0:N−1] respectively include circuitry 454[0:N−1], collectively circuitry 454. Circuitry 454 represents circuitry that interfaces arrays 452 to store data from DQ bus 464[B] in response to a write command, and provide data to DQ bus 464[B] in response to a read command. In one example, circuitry 454 enables DRAM devices 450 to perform internal training sweeps in accordance with any example described herein.

DRAM devices 440 and DRAM device 450 are illustrated as having a xM interface, with M data bus pins, DQ[0:(M−1)]. M can be any integer and is typically a binary integer such as 4, 8, or 16. Each DQ interface will transmit data bits over a burst length (BL), such as BL16 for a 46 unit interval or transfer cycle data exchange. Thus, the data transfer is BL×M, such as a x4 interface (e.g., M=4) with BL16 (e.g., 16 unit intervals (UIs) of transfer) for 4×16=64 bits per device.

Memory controller 410 includes command 412, which represents logic at memory controller 410 to send commands to the DRAM devices. In one example, memory controller 410 includes training 414 to initiate and manage training of the interfaces with the DRAM devices of DIMM 420. In one example, training 414 enables memory controller 410 to generate training patterns for the training modes.

Command 412 enables memory controller 410 to send commands to initiate training modes, and then to send commands to provide the training data patterns. Memory controller 410 can aggregate results information and perform measurement to determine the best configuration settings for the interfaces.

The DRAM devices can include circuitry to implement the internal training sweeps. Thus, command 412 can initiate the training mode, and then does not have to send command to cause the DRAM devices to transition parameter values for the sweeps. Rather, the DRAM devices can generate the sweeps internally. In one example, each DRAM device includes an LFSR per DQ of the physical interface to generate sweep patterns. The training modes with internal sweeps managed by the DRAM devices can be for the CA buses, the DQ buses, and DQS signal lines.

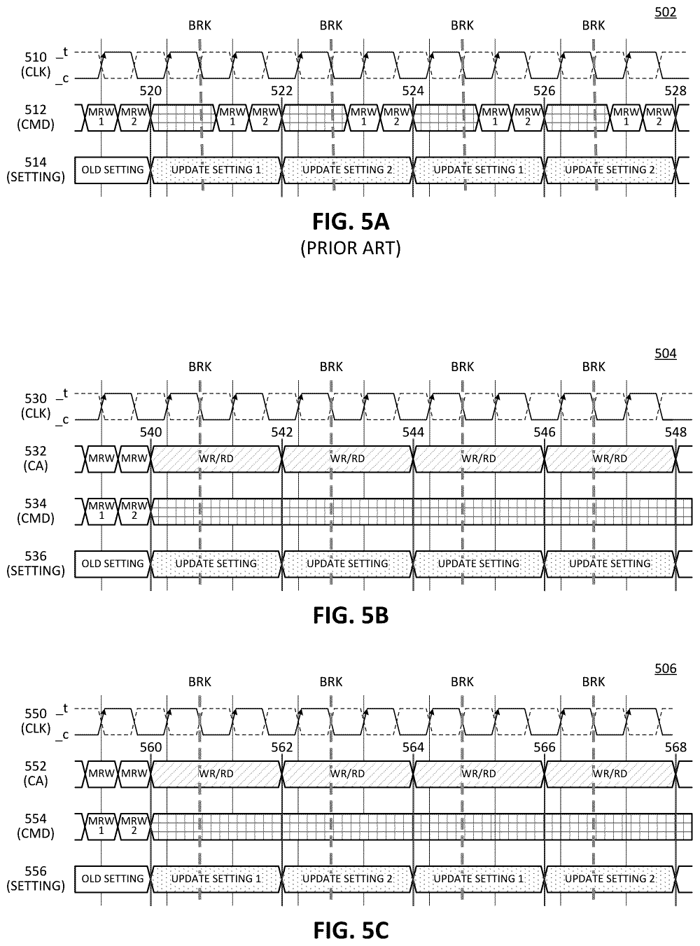

FIG. 5A is a timing diagram example of prior art training sweep. Diagram 502 illustrates various signals and example sequences over time. The thick dashed lines labeled “BRK” represent time breaks, thus indicating that the number of clock cycles involved in the signaling can vary from what is illustrated.

Signal 510 represents the clock (CLK), which has CK_t (clock primary) and CK_c (clock complementary) signals, which represent the timing signals. Signal 512 represents the internal command signal, CMD (command). The CMD signal represents the decoded operation internal to the DRAM device in response to the host command. Signal line 514 represents the setting of a configuration parameter.

In diagram 502, the host sends a command per value. Thus, signal line 512 illustrates MRW 1 and MRW 2 (first and second phases of a mode register write command) to trigger value changes at point 520, point 522, point 524, point 526, and point 528. It will be understood that instead of MRW commands, the commands could be MPC commands.

It will be understood that to change Setting 1, the system sends the first MRW command to begin sweeping parameter setting 1 at 520. The system then must interrupt the training mode with another MRW command to initiate a sweep at 522 of parameter setting 2. The system will return to the training mode for setting 1 at 524, interrupt again to sweep setting 2 at 526, and continue in that pattern at 528 until the configuration parameter sweeps are complete.

FIG. 5B is a timing diagram example of autonomous training sweeps for a configuration parameter. Diagram 504 illustrates various signals and example sequences over time. The thick dashed lines labeled “BRK” represent time breaks, thus indicating that the number of clock cycles involved in the signaling can vary from what is illustrated.

Signal 530 represents the clock (CLK), which has CK_t (clock primary) and CK_c (clock complementary) signals, which represent the timing signals. Signal 532 represents the command and address signal lines, CA (command/address), which represents a command sent by the host. Signal 534 represents the internal command signal, CMD (command). The CMD signal represents the decoded operation internal to the DRAM device in response to the host command. Signal line 536 represents the setting of a configuration parameter.

In diagram 504, the host does not send a command per value of the sweep, because the memory device manages the sweep internally. Thus, signal line 532 illustrates the MRW commands, decoded as MRW 1 and MRW 2 (first and second phases of a mode register write command) in signal 534, only at the beginning to trigger the training mode at point 540. It will be understood that instead of MRW commands, the commands could be MPC commands. In one example, instead of an MRW command or an MPC command, the system can trigger the training mode through an MRUPD (mode register update) command, performing the training in an MRUPD mode.

It will be understood that to change the configuration setting, the system sends the MRW command to begin sweeping the configuration parameter setting at 540. The host then continues to send the training patterns via write and read (WR/RD) commands and does not have to send additional MRW commands. Thus, signal 534 illustrates the initiate MRW command, followed by no additional MRW commands. In one example, the memory device monitors the WR and RD commands to count how many commands are received to trigger transition from one configuration parameter value to the next. In one example, the memory device counts CS assertions from the read and write commands. Internally, the memory device determines to transition the sweep at point 542, at point 544, at point 546, at point 548, and so forth until the training sweeps are complete.

FIG. 5C is a timing diagram example of autonomous training sweeps for multiple configuration parameters. Diagram 506 illustrates various signals and example sequences over time. The thick dashed lines labeled “BRK” represent time breaks, thus indicating that the number of clock cycles involved in the signaling can vary from what is illustrated.

Signal 550 represents the clock (CLK), which has CK_t (clock primary) and CK_c (clock complementary) signals, which represent the timing signals. Signal 552 represents the command and address signal lines, CA (command/address), which represents a command sent by the host. Signal 554 represents the internal command signal, CMD (command). The CMD signal represents the decoded operation internal to the DRAM device in response to the host command. Signal line 556 represents the setting of a configuration parameter.

In diagram 506, the host does not send a command per value of the sweep, because the memory device manages the sweep internally. Thus, signal line 552 illustrates the MRW commands, decoded as MRW 1 and MRW 2 (first and second phases of a mode register write command) in signal 554, only at the beginning to trigger the training mode at point 560. It will be understood that instead of MRW commands, the commands could be MPC commands. In one example, instead of an MRW command or an MPC command, the system can trigger the training mode through an MRUPD (mode register update) command, performing the training in an MRUPD mode.

It will be understood that to change the configuration setting, the system sends the MRW command to begin sweeping parameter setting 1 at 560. The host then continues to send the training patterns via write and read (WR/RD) commands and does not have to send additional MRW commands. Thus, signal 554 illustrates the initiate MRW command, followed by no additional MRW commands. In one example, the memory device monitors the WR and RD commands to count how many commands are received to trigger transition from one configuration parameter value to the next. In one example, the memory device counts CS assertions from the read and write commands.

Internally, the memory device determines to transition the sweep at point 562 to update configuration setting 2, then at point 564 to update configuration setting 1, then at point 566 to again update configuration setting 2, and again to transition at point 568, and so forth until the training sweeps are complete.

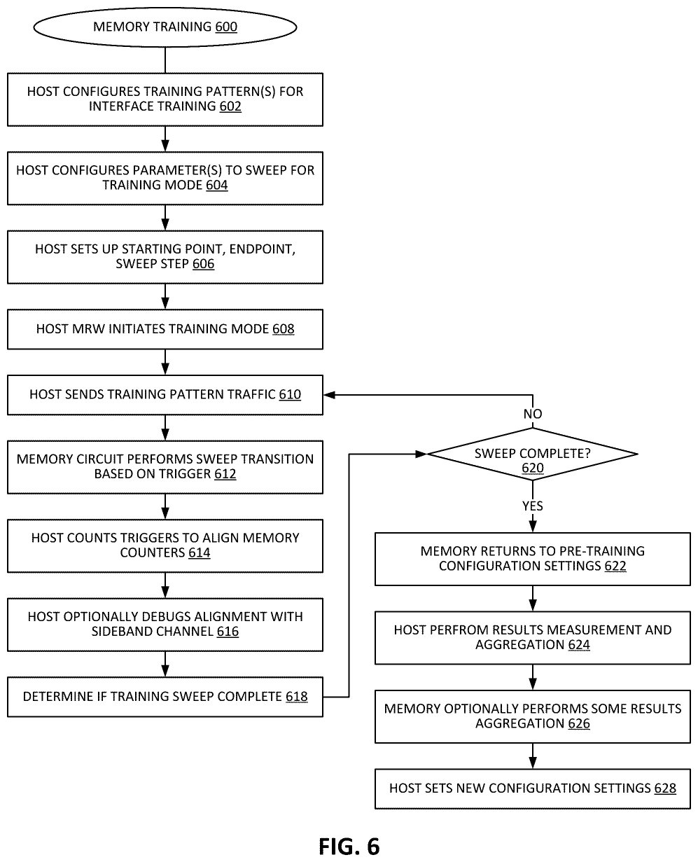

FIG. 6 is a flow diagram of an example of a process for memory training. Process 600 illustrates an example of a process for training the I/O interface for a memory in a system in accordance with any example herein. More specifically, in process 600, the memory internally performs configuration parameter sweeps without the host sending a specific command to transition parameter values.

In one example, the host configures the training pattern or training patterns for the interface training, at 602. In one example, the training pattern is for 1D training. In one example, the training pattern is for 2D training. The host configures the parameters to sweep for the particular training mode, at 604. As an example, the host can setup training for CSTM (chip select training mode), with QCS delay settings for the RCD, CSVref for the DRAM, and other parameters.

The host sets up the starting point, endpoints, and the sweep step size, at 606. The sweep step size refers to the amount of change from one configuration parameter value tested to the next value in the sweep. The host can generate an MRW command, MPC command, or MRUPD command to initiate the training mode, at 608. The host then sends training pattern traffic, at 610, without needing to send additional MRW/MPC commands.

The memory performs the sweep internally. A circuit in the memory performs sweep transitions based on a detected/monitored trigger, at 612. In one example, the trigger to move to the parameter value is a count of the CS assertions (e.g., in CA/CS training modes or CS assertions from Writes and Reads). In one example, the trigger is a programmable value, allowing the system to set how many items are needed to cause a change of value in the sweep. In one example, the host also counts the triggers to align to the memory counters for the auto increment, at 614.

In one example, the host optionally debugs counter alignment with a sideband channel (e.g., M3C), at 616. The host can determine if the sweep is complete, at 618. If the sweep is not complete, at 620 NO branch, the host continues to send pattern traffic, at 610, and the memory continues to perform sweeping internally.

If the sweep is complete, at 620 YES branch, the host can send an indication to the memory that the sweep is complete. In one example, the memory returns to pre-training configuration settings, at 622. The pre-training settings can be default settings. In one example, the memory stores state to know what its configuration was prior to training, and returns to that configuration state instead of to a default setting state.

The host performs results measurement and aggregation, at 624, based on the training. In one example, the memory optionally performs some results aggregation, at 626. For example, the memory can perform some aggregation in the DRAM for CS training and CA training and in the DB for backside DQ training. The host can then compute and set the new configuration settings, at 628.

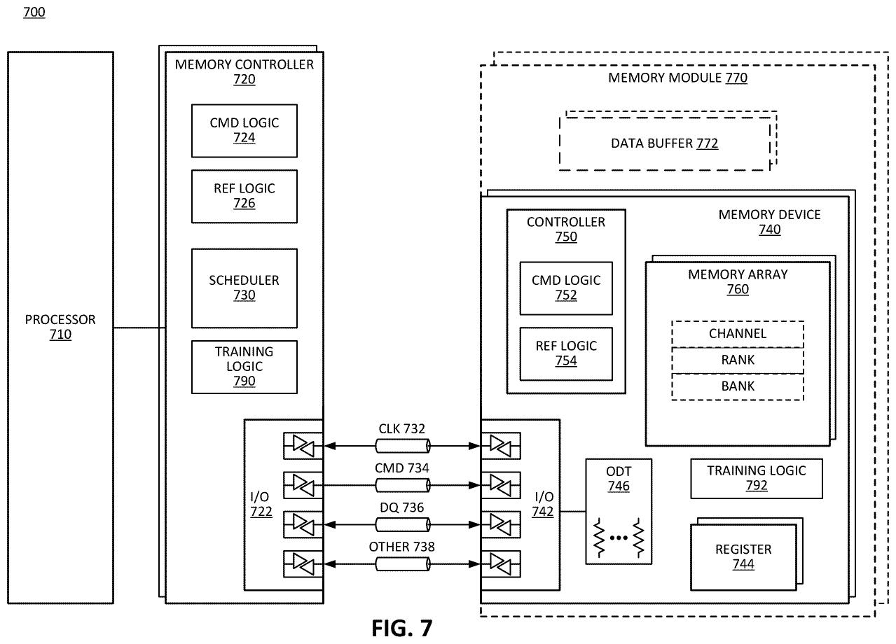

FIG. 7 is a block diagram of an example of a memory subsystem in which autonomous training sweeps can be implemented. System 700 includes a processor and elements of a memory subsystem in a computing device.

System 700 represents a system with a memory subsystem in accordance with an example of system 100, an example of system 200, an example of system 302, and example of system 304, or an example of system 400. In one example, system 700 includes training logic 792 in memory device 740. Training logic 792 represents in-built logic in the memory device to enable memory device 740 to internally perform parameter sweeps for I/O training. The internal sweeping can be in accordance with any example herein. System 700 also illustrates training logic 790 in memory controller 720, which represents training logic in the memory controller. Training logic 790 knows that memory device 740 is enabled to internally perform parameter sweeps, and thus, memory controller 720 will only send a command to initiate the training mode, and it will send the training pattern traffic, but will allow the memory to internally handle parameter sweeps. In one example, system 700 includes data buffer 772 in memory module 770. Data buffer 772 represents data buffers coupled between memory device 740 and DQ 736. In such an implementation with data buffers, the data buffers can include training logic similar to what is described for memory device 740.

Processor 710 represents a processing unit of a computing platform that may execute an operating system (OS) and applications, which can collectively be referred to as the host or the user of the memory. The OS and applications execute operations that result in memory accesses. Processor 710 can include one or more separate processors. Each separate processor can include a single processing unit, a multicore processing unit, or a combination. The processing unit can be a primary processor such as a CPU (central processing unit), a peripheral processor such as a GPU (graphics processing unit), or a combination. Memory accesses may also be initiated by devices such as a network controller or hard disk controller. Such devices can be integrated with the processor in some systems or attached to the processer via a bus (e.g., PCI express), or a combination. System 700 can be implemented as an SOC (system on a chip), or be implemented with standalone components.

Reference to memory devices can apply to different memory types. Memory devices often refers to volatile memory technologies. Volatile memory is memory whose state (and therefore the data stored on it) is indeterminate if power is interrupted to the device. Nonvolatile memory refers to memory whose state is determinate even if power is interrupted to the device. Dynamic volatile memory requires refreshing the data stored in the device to maintain state. One example of dynamic volatile memory includes DRAM (dynamic random-access memory), or some variant such as synchronous DRAM (SDRAM). A memory subsystem as described herein may be compatible with a number of memory technologies, such as DDR4 (double data rate version 4, JESD79-4, originally published in September 2012 by JEDEC (Joint Electron Device Engineering Council, now the JEDEC Solid State Technology Association), LPDDR4 (low power DDR version 4, JESD209-4, originally published by JEDEC in August 2014), WIO2 (Wide I/O 2 (WideIO2), JESD229-2, originally published by JEDEC in August 2014), HBM (high bandwidth memory DRAM, JESD235A, originally published by JEDEC in November 2015), DDR5 (DDR version 5, originally published by JEDEC in July 2020), LPDDR5 (LPDDR version 5, JESD209-5, originally published by JEDEC in February 2019), HBM2 (HBM version 2, JESD235C, originally published by JEDEC in January 2020), HBM3 (HBM version 3, JESD238, originally published by JEDEC in January 2022), DDR6 (DDR version 6, in discussion), GDDR7 (graphics DDR version 7, in discussion), or others or combinations of memory technologies, and technologies based on derivatives or extensions of such specifications.

Memory controller 720 represents one or more memory controller circuits or devices for system 700. In one example, memory controller 720 is on the same semiconductor substrate as processor 710. Memory controller 720 represents control logic that generates memory access commands in response to the execution of operations by processor 710. Memory controller 720 accesses one or more memory devices 740. Memory devices 740 can be DRAM devices in accordance with any referred to above. In one example, memory devices 740 are organized and managed as different channels, where each channel couples to buses and signal lines that couple to multiple memory devices in parallel. Each channel is independently operable. Thus, each channel is independently accessed and controlled, and the timing, data transfer, command and address exchanges, and other operations are separate for each channel. Coupling can refer to an electrical coupling, communicative coupling, physical coupling, or a combination of these. Physical coupling can include direct contact. Electrical coupling includes an interface or interconnection that allows electrical flow between components, or allows signaling between components, or both. Communicative coupling includes connections, including wired or wireless, that enable components to exchange data.

In one example, settings for each channel are controlled by separate mode registers or other register settings. In one example, each memory controller 720 manages a separate memory channel, although system 700 can be configured to have multiple channels managed by a single controller, or to have multiple controllers on a single channel. In one example, memory controller 720 is part of host processor 710, such as logic implemented on the same die or implemented in the same package space as the processor.

Memory controller 720 includes I/O interface logic 722 to couple to a memory bus, such as a memory channel as referred to above. I/O interface logic 722 (as well as I/O interface logic 742 of memory device 740) can include pins, pads, connectors, signal lines, traces, or wires, or other hardware to connect the devices, or a combination of these. I/O interface logic 722 can include a hardware interface. As illustrated, I/O interface logic 722 includes at least drivers/transceivers for signal lines. Commonly, wires within an integrated circuit interface couple with a pad, pin, or connector to interface signal lines or traces or other wires between devices. I/O interface logic 722 can include drivers, receivers, transceivers, or termination, or other circuitry or combinations of circuitry to exchange signals on the signal lines between the devices. The exchange of signals includes at least one of transmit or receive. While shown as coupling I/O 722 from memory controller 720 to I/O 742 of memory device 740, it will be understood that in an implementation of system 700 where groups of memory devices 740 are accessed in parallel, multiple memory devices can include I/O interfaces to the same interface of memory controller 720. In an implementation of system 700 including one or more memory modules 770, I/O 742 can include interface hardware of the memory module in addition to interface hardware on the memory device itself. Other memory controllers 720 will include separate interfaces to other memory devices 740.

The bus between memory controller 720 and memory devices 740 can be implemented as multiple signal lines coupling memory controller 720 to memory devices 740. The bus may typically include at least clock (CLK) 732, command/address (CMD) 734, data (DQ) 736, and zero or more other signal lines 738. In one example, a bus or connection between memory controller 720 and memory can be referred to as a memory bus. In one example, the memory bus is a multi-drop bus. The signal lines for CMD can be referred to as a “C/A bus” (or ADD/CMD bus, or some other designation indicating the transfer of commands (C or CMD) and address (A or ADD) information) and the signal lines for write and read DQ can be referred to as a “data bus.” In one example, independent channels have different clock signals, C/A buses, data buses, and other signal lines. Thus, system 700 can be considered to have multiple “buses,” in the sense that an independent interface path can be considered a separate bus. It will be understood that in addition to the lines explicitly shown, a bus can include at least one of strobe signaling lines, alert lines, auxiliary lines, or other signal lines, or a combination. It will also be understood that serial bus technologies can be used for the connection between memory controller 720 and memory devices 740. An example of a serial bus technology is 8B10B encoding and transmission of high-speed data with embedded clock over a single differential pair of signals in each direction. In one example, CMD 734 represents signal lines shared in parallel with multiple memory devices. In one example, multiple memory devices share encoding command signal lines of CMD 734, and each has a separate chip select (CS_n) signal line to select individual memory devices.

It will be understood that in the example of system 700, the bus between memory controller 720 and memory devices 740 includes a subsidiary command bus CMD 734 and a subsidiary bus to carry the write and read data, DQ 736. In one example, the data bus can include bidirectional lines for read data and for write/command data. In another example, the subsidiary bus DQ 736 can include unidirectional write signal lines for write and data from the host to memory, and can include unidirectional lines for read data from the memory to the host. In accordance with the chosen memory technology and system design, other signals 738 may accompany a bus or sub bus, such as strobe lines DQS. Based on design of system 700, or implementation if a design supports multiple implementations, the data bus can have more or less bandwidth per memory device 740. For example, the data bus can support memory devices that have either a x4 interface, a x8 interface, a x16 interface, or other interface. The convention “xW,” where W is an integer that refers to an interface size or width of the interface of memory device 740, which represents a number of signal lines to exchange data with memory controller 720. The interface size of the memory devices is a controlling factor on how many memory devices can be used concurrently per channel in system 700 or coupled in parallel to the same signal lines. In one example, high bandwidth memory devices, wide interface devices, or stacked memory configurations, or combinations, can enable wider interfaces, such as a x128 interface, a x256 interface, a x512 interface, a x1024 interface, or other data bus interface width.

In one example, memory devices 740 and memory controller 720 exchange data over the data bus in a burst, or a sequence of consecutive data transfers. The burst corresponds to a number of transfer cycles, which is related to a bus frequency. In one example, the transfer cycle can be a whole clock cycle for transfers occurring on a same clock or strobe signal edge (e.g., on the rising edge). In one example, every clock cycle, referring to a cycle of the system clock, is separated into multiple unit intervals (UIs), where each UI is a transfer cycle. For example, double data rate transfers trigger on both edges of the clock signal (e.g., rising and falling). A burst can last for a configured number of UIs, which can be a configuration stored in a register, or triggered on the fly. For example, a sequence of eight consecutive transfer periods can be considered a burst length eight (BL8), and each memory device 740 can transfer data on each UI. Thus, a x8 memory device operating on BL8 can transfer 64 bits of data (8 data signal lines times 8 data bits transferred per line over the burst). It will be understood that this simple example is merely an illustration and is not limiting.

Memory devices 740 represent memory resources for system 700. In one example, each memory device 740 is a separate memory die. In one example, each memory device 740 can interface with multiple (e.g., 2) channels per device or die. Each memory device 740 includes I/O interface logic 742, which has a bandwidth determined by the implementation of the device (e.g., x16 or x8 or some other interface bandwidth). I/O interface logic 742 enables the memory devices to interface with memory controller 720. I/O interface logic 742 can include a hardware interface, and can be in accordance with I/O 722 of memory controller, but at the memory device end. In one example, multiple memory devices 740 are connected in parallel to the same command and data buses. In another example, multiple memory devices 740 are connected in parallel to the same command bus, and are connected to different data buses. For example, system 700 can be configured with multiple memory devices 740 coupled in parallel, with each memory device responding to a command, and accessing memory resources 760 internal to each. For a Write operation, an individual memory device 740 can write a portion of the overall data word, and for a Read operation, an individual memory device 740 can fetch a portion of the overall data word. The remaining bits of the word will be provided or received by other memory devices in parallel.

In one example, memory devices 740 are disposed directly on a motherboard or host system platform (e.g., a PCB (printed circuit board) or substrate on which processor 710 is disposed) of a computing device. In one example, memory devices 740 can be organized into memory modules 770. In one example, memory modules 770 represent dual inline memory modules (DIMMs). In one example, memory modules 770 represent other organization of multiple memory devices to share at least a portion of access or control circuitry, which can be a separate circuit, a separate device, or a separate board from the host system platform. Memory modules 770 can include multiple memory devices 740, and the memory modules can include support for multiple separate channels to the included memory devices disposed on them. In another example, memory devices 740 may be incorporated into the same package as memory controller 720, such as by techniques such as multi-chip-module (MCM), package-on-package, through-silicon via (TSV), or other techniques or combinations. Similarly, in one example, multiple memory devices 740 may be incorporated into memory modules 770, which themselves may be incorporated into the same package as memory controller 720. It will be appreciated that for these and other implementations, memory controller 720 may be part of host processor 710.

Memory devices 740 each include one or more memory arrays 760. Memory array 760 represents addressable memory locations or storage locations for data. Typically, memory array 760 is managed as rows of data, accessed via wordline (rows) and bitline (individual bits within a row) control. Memory array 760 can be organized as separate channels, ranks, and banks of memory. Channels may refer to independent control paths to storage locations within memory devices 740. Ranks may refer to common locations across multiple memory devices (e.g., same row addresses within different devices) in parallel. Banks may refer to sub-arrays of memory locations within a memory device 740. In one example, banks of memory are divided into sub-banks with at least a portion of shared circuitry (e.g., drivers, signal lines, control logic) for the sub-banks, allowing separate addressing and access. It will be understood that channels, ranks, banks, sub-banks, bank groups, or other organizations of the memory locations, and combinations of the organizations, can overlap in their application to physical resources. For example, the same physical memory locations can be accessed over a specific channel as a specific bank, which can also belong to a rank. Thus, the organization of memory resources will be understood in an inclusive, rather than exclusive, manner.

In one example, memory devices 740 include one or more registers 744. Register 744 represents one or more storage devices or storage locations that provide configuration or settings for the operation of the memory device. In one example, register 744 can provide a storage location for memory device 740 to store data for access by memory controller 720 as part of a control or management operation. In one example, register 744 includes one or more Mode Registers. In one example, register 744 includes one or more multipurpose registers. The configuration of locations within register 744 can configure memory device 740 to operate in different “modes,” where command information can trigger different operations within memory device 740 based on the mode. Additionally or in the alternative, different modes can also trigger different operation from address information or other signal lines depending on the mode. Settings of register 744 can indicate configuration for I/O settings (e.g., timing, termination or ODT (on-die termination) 746, driver configuration, or other I/O settings).

In one example, memory device 740 includes ODT 746 as part of the interface hardware associated with I/O 742. ODT 746 can be configured as mentioned above, and provide settings for impedance to be applied to the interface to specified signal lines. In one example, ODT 746 is applied to DQ signal lines. In one example, ODT 746 is applied to command signal lines. In one example, ODT 746 is applied to address signal lines. In one example, ODT 746 can be applied to any combination of the preceding. The ODT settings can be changed based on whether a memory device is a selected target of an access operation or a non-target device. ODT 746 settings can affect the timing and reflections of signaling on the terminated lines. Careful control over ODT 746 can enable higher-speed operation with improved matching of applied impedance and loading. ODT 746 can be applied to specific signal lines of I/O interface 742, 722 (for example, ODT for DQ lines or ODT for CA lines), and is not necessarily applied to all signal lines.

Memory device 740 includes controller 750, which represents control logic within the memory device to control internal operations within the memory device. For example, controller 750 decodes commands sent by memory controller 720 and generates internal operations to execute or satisfy the commands. Controller 750 can be referred to as an internal controller, and is separate from memory controller 720 of the host. Controller 750 can determine what mode is selected based on register 744, and configure the internal execution of operations for access to memory resources 760 or other operations based on the selected mode. Controller 750 generates control signals to control the routing of bits within memory device 740 to provide a proper interface for the selected mode and direct a command to the proper memory locations or addresses. Controller 750 includes command logic 752, which can decode command encoding received on command and address signal lines. Thus, command logic 752 can be or include a command decoder. With command logic 752, memory device can identify commands and generate internal operations to execute requested commands.

Referring again to memory controller 720, memory controller 720 includes command (CMD) logic 724, which represents logic or circuitry to generate commands to send to memory devices 740. The generation of the commands can refer to the command prior to scheduling, or the preparation of queued commands ready to be sent. Generally, the signaling in memory subsystems includes address information within or accompanying the command to indicate or select one or more memory locations where the memory devices should execute the command. In response to scheduling of transactions for memory device 740, memory controller 720 can issue commands via I/O 722 to cause memory device 740 to execute the commands. In one example, controller 750 of memory device 740 receives and decodes command and address information received via I/O 742 from memory controller 720. Based on the received command and address information, controller 750 can control the timing of operations of the logic and circuitry within memory device 740 to execute the commands. Controller 750 is responsible for compliance with standards or specifications within memory device 740, such as timing and signaling requirements. Memory controller 720 can implement compliance with standards or specifications by access scheduling and control.

Memory controller 720 includes scheduler 730, which represents logic or circuitry to generate and order transactions to send to memory device 740. From one perspective, the primary function of memory controller 720 could be said to schedule memory access and other transactions to memory device 740. Such scheduling can include generating the transactions themselves to implement the requests for data by processor 710 and to maintain integrity of the data (e.g., such as with commands related to refresh). Transactions can include one or more commands, and result in the transfer of commands or data or both over one or multiple timing cycles such as clock cycles or unit intervals. Transactions can be for access such as read or write or related commands or a combination, and other transactions can include memory management commands for configuration, settings, data integrity, or other commands or a combination.

Memory controller 720 typically includes logic such as scheduler 730 to allow selection and ordering of transactions to improve performance of system 700. Thus, memory controller 720 can select which of the outstanding transactions should be sent to memory device 740 in which order, which is typically achieved with logic much more complex that a simple first-in first-out algorithm. Memory controller 720 manages the transmission of the transactions to memory device 740, and manages the timing associated with the transaction. In one example, transactions have deterministic timing, which can be managed by memory controller 720 and used in determining how to schedule the transactions with scheduler 730.

In one example, memory controller 720 includes refresh (REF) logic 726. Refresh logic 726 can be used for memory resources that are volatile and need to be refreshed to retain a deterministic state. In one example, refresh logic 726 indicates a location for refresh, and a type of refresh to perform. Refresh logic 726 can trigger self-refresh within memory device 740, or execute external refreshes which can be referred to as auto refresh commands) by sending refresh commands, or a combination. In one example, controller 750 within memory device 740 includes refresh logic 754 to apply refresh within memory device 740. In one example, refresh logic 754 generates internal operations to perform refresh in accordance with an external refresh received from memory controller 720. Refresh logic 754 can determine if a refresh is directed to memory device 740, and what memory resources 760 to refresh in response to the command.

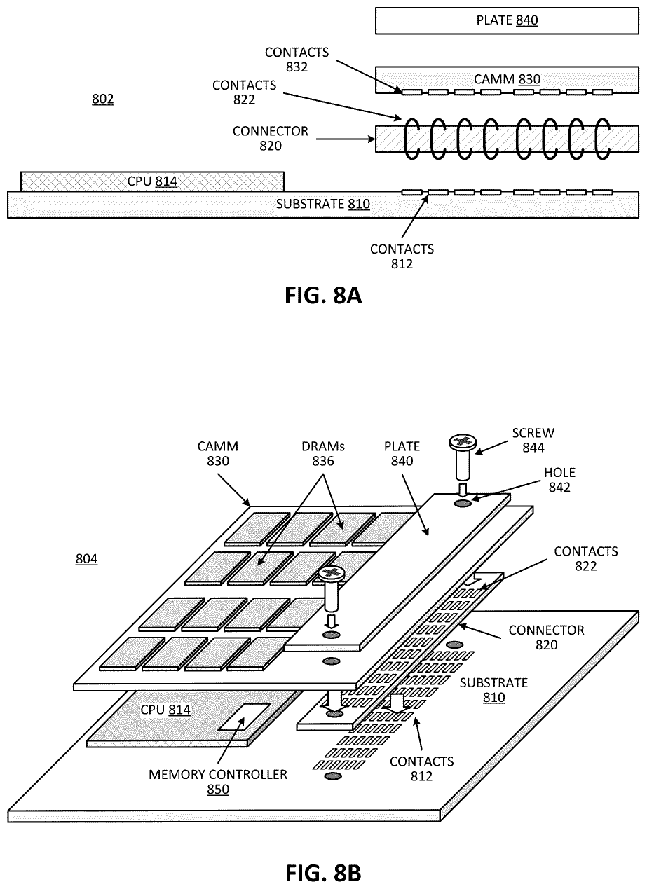

FIGS. 8A-8B are block diagrams of an example of a CAMM system in which autonomous training sweeps can be implemented.

Referring to FIG. 8A, system 802 includes a memory stack architecture. System 802 is an example of a system in accordance with an example of system 100, an example of system 200, an example of system 302, and example of system 304, or an example of system 400. In one example, the DRAMs of CAMM 830 can perform internal parameter sweeps, in accordance with any example herein.

Substrate 810 illustrates an SOC package substrate or a motherboard or system board. Substrate 810 includes contacts 812, which represent contacts for connecting with memory. CPU 814 represents a processor or central processing unit (CPU) chip or graphics processing unit (GPU) chip to be disposed on substrate 810. CPU 814 performs the computational operations in system 802. In one example, CPU 814 includes multiple cores (not specifically shown), which can generate operations that request data to be read from and written to memory. CPU 814 can include a memory controller to manage access to the memory devices.

Compression-attached memory module (CAMM) 830 represents a module with memory devices, which are not specifically illustrated in system 802. Substrate 810 couples to CAMM 830 and its memory devices through compression mount technology (CMT) connector 820. Connector 820 includes contacts 822, which are compression-based contacts. The compression-based contacts are compressible pins or devices whose shape compresses with the application of pressure on connector 820. In one example, contacts 822 represent C-shaped pins as illustrated. In one example, contacts 822 represent another compressible pin shape, such as a spring-shape, an S-shape, or pins having other shapes that can be compressed.

CAMM 830 includes contacts 832 on a side of the CAMM board that interfaces with connector 820. Contacts 832 connect to memory devices on the CAMM board. Plate 840 represents a plate or housing that provides structure to apply pressure to compress contacts 822 of connector 820.

Referring to FIG. 8B, system 804 is a perspective view of a system in accordance with system 802. CAMM 830 is illustrated with memory chips or memory dies, identified as DRAMs 836 on one or both faces of the PCB of CAMM 830. DRAMs 836 are coupled with conductive contacts via conductive traces in or on the PCB, which couples with contacts 832, which in turn couple with contacts 822 of connector 820.

System 804 illustrates holes 842 in plate 840 to receive fasteners, represented by screws 844. There are corresponding holes through CAMM 830, connector 820, and in substrate 810. Screws 844 can compressibly attach the CAMM 830 to substrate 810 via connector 820.

System 804 illustrates memory controller 850, which is not specifically illustrated in system 802. Memory controller 850 can work in conjunction with DRAMs 836 to perform I/O training in accordance with any example herein. More specifically, memory controller 850 places the DRAMs in a training mode, and the DRAMs internally handle parameter sweeps. Memory controller 850 can then determine the appropriate configuration settings, and set the configuration with the determined parameters.

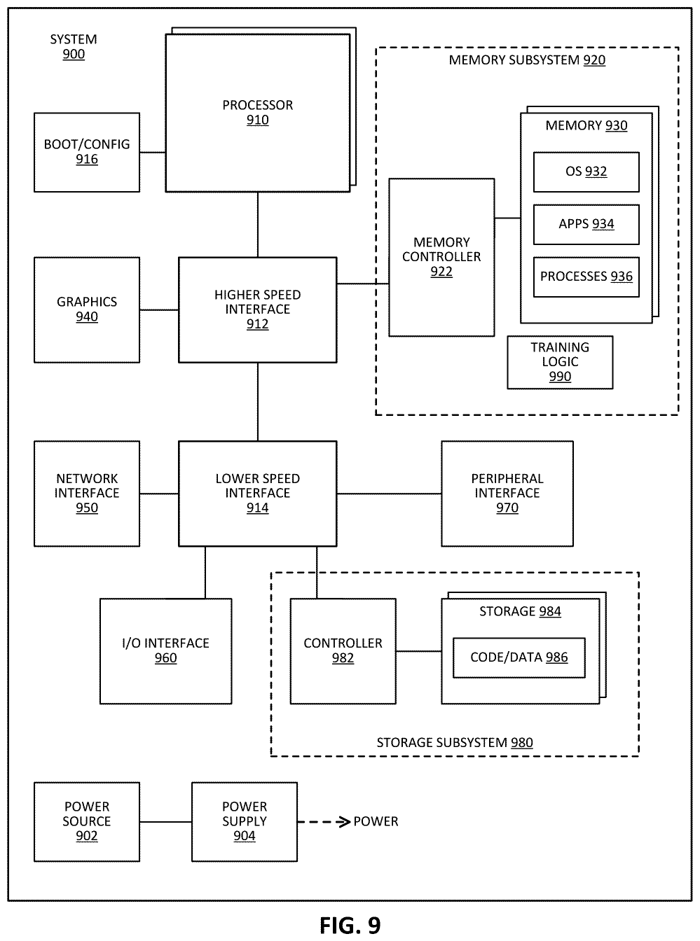

FIG. 9 is a block diagram of an example of a computing system in which autonomous training sweeps can be implemented. System 900 represents a computing device in accordance with any example herein, and can be a laptop computer, a desktop computer, a tablet computer, a server, a gaming or entertainment control system, embedded computing device, or other electronic device.

System 900 represents a system with a memory subsystem in accordance with an example of system 100, an example of system 200, an example of system 302, and example of system 304, or an example of system 400. In one example, system 900 includes training logic 990 in memory subsystem 920. Training logic 990 represents in-built logic in memory 930 and logic in memory controller 922. With training logic 990, memory controller 922 knows that memory 930 is enabled to internally perform parameter sweeps, and thus, will only send a command to initiate the training mode, and it will send the training pattern traffic, but will allow the memory to internally handle parameter sweeps. With training logic 990, memory 930 is enabled to internally perform parameter sweeps for I/O training. The internal sweeping can be in accordance with any example herein.

System 900 includes processor 910 can include any type of microprocessor, central processing unit (CPU), graphics processing unit (GPU), processing core, or other processing hardware, or a combination, to provide processing or execution of instructions for system 900. Processor 910 can be a host processor device. Processor 910 controls the overall operation of system 900, and can be or include, one or more programmable general-purpose or special-purpose microprocessors, digital signal processors (DSPs), programmable controllers, application specific integrated circuits (ASICs), programmable logic devices (PLDs), or a combination of such devices.

System 900 includes boot/config 916, which represents storage to store boot code (e.g., basic input/output system (BIOS)), configuration settings, security hardware (e.g., trusted platform module (TPM)), or other system level hardware that operates outside of a host OS. Boot/config 916 can include a nonvolatile storage device, such as read-only memory (ROM), flash memory, or other memory devices.

In one example, system 900 includes interface 912 coupled to processor 910, which can represent a higher speed interface or a high throughput interface for system components that need higher bandwidth connections, such as memory subsystem 920 or graphics interface components 940. Interface 912 represents an interface circuit, which can be a standalone component or integrated onto a processor die. Interface 912 can be integrated as a circuit onto the processor die or integrated as a component on a system on a chip. Where present, graphics interface 940 interfaces to graphics components for providing a visual display to a user of system 900. Graphics interface 940 can be a standalone component or integrated onto the processor die or system on a chip. In one example, graphics interface 940 can drive a high definition (HD) display or ultra high definition (UHD) display that provides an output to a user. In one example, the display can include a touchscreen display. In one example, graphics interface 940 generates a display based on data stored in memory 930 or based on operations executed by processor 910 or both.

Memory subsystem 920 represents the main memory of system 900, and provides storage for code to be executed by processor 910, or data values to be used in executing a routine. Memory subsystem 920 can include one or more varieties of random-access memory (RAM) such as DRAM, 3DXP (three-dimensional crosspoint), or other memory devices, or a combination of such devices. Memory 930 stores and hosts, among other things, operating system (OS) 932 to provide a software platform for execution of instructions in system 900. Additionally, applications 934 can execute on the software platform of OS 932 from memory 930. Applications 934 represent programs that have their own operational logic to perform execution of one or more functions. Processes 936 represent agents or routines that provide auxiliary functions to OS 932 or one or more applications 934 or a combination. OS 932, applications 934, and processes 936 provide software logic to provide functions for system 900. In one example, memory subsystem 920 includes memory controller 922, which is a memory controller to generate and issue commands to memory 930. It will be understood that memory controller 922 could be a physical part of processor 910 or a physical part of interface 912. For example, memory controller 922 can be an integrated memory controller, integrated onto a circuit with processor 910, such as integrated onto the processor die or a system on a chip.

While not specifically illustrated, it will be understood that system 900 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a HyperTransport or industry standard architecture (ISA) bus, a small computer system interface (SCSI) bus, a universal serial bus (USB), or other bus, or a combination.

In one example, system 900 includes interface 914, which can be coupled to interface 912. Interface 914 can be a lower speed interface than interface 912. In one example, interface 914 represents an interface circuit, which can include standalone components and integrated circuitry. In one example, multiple user interface components or peripheral components, or both, couple to interface 914. Network interface 950 provides system 900 the ability to communicate with remote devices (e.g., servers or other computing devices) over one or more networks. Network interface 960 can represent a network interface circuit (NIC) that enables connection with a remote device over a network connection. The network connection enabled by network interface 950 can include an Ethernet adapter, wireless interconnection components, cellular network interconnection components, USB (universal serial bus), or other wired or wireless standards-based or proprietary interfaces. Network interface 950 can exchange data with a remote device, which can include sending data stored in memory or receiving data to be stored in memory.

In one example, system 900 includes one or more input/output (I/O) interface(s) 960. I/O interface 960 can include one or more interface components through which a user interacts with system 900 (e.g., audio, alphanumeric, tactile/touch, or other interfacing). Peripheral interface 970 can include any hardware interface not specifically mentioned above. Peripherals refer generally to devices that connect dependently to system 900. A dependent connection is one where system 900 provides the software platform or hardware platform or both on which operation executes, and with which a user interacts.

In one example, system 900 includes storage subsystem 980 to store data in a nonvolatile manner. In one example, in certain system implementations, at least certain components of storage 980 can overlap with components of memory subsystem 920. Storage subsystem 980 includes storage device(s) 984, which can be or include any conventional medium for storing large amounts of data in a nonvolatile manner, such as one or more magnetic, solid state, NAND, 3DXP, or optical based disks, or a combination. Storage 984 holds code or instructions and data 986 in a persistent state (i.e., the value is retained despite interruption of power to system 900). Storage 984 can be generically considered to be a “memory,” although memory 930 is typically the executing or operating memory to provide instructions to processor 910. Whereas storage 984 is nonvolatile, memory 930 can include volatile memory (i.e., the value or state of the data is indeterminate if power is interrupted to system 900). In one example, storage subsystem 980 includes controller 982 to interface with storage 984. In one example controller 982 is a physical part of interface 914 or processor 910, or can include circuits or logic in both processor 910 and interface 914.

Power source 902 provides power to the components of system 900. More specifically, power source 902 typically interfaces to one or multiple power supplies 904 in system 900 to provide power to the components of system 900. In one example, power supply 904 includes an AC to DC (alternating current to direct current) adapter to plug into a wall outlet. Such AC power can be renewable energy (e.g., solar power) power source 902. In one example, power source 902 includes a DC power source, such as an external AC to DC converter. In one example, power source 902 or power supply 904 includes wireless charging hardware to charge via proximity to a charging field. In one example, power source 902 can include an internal battery or fuel cell source.

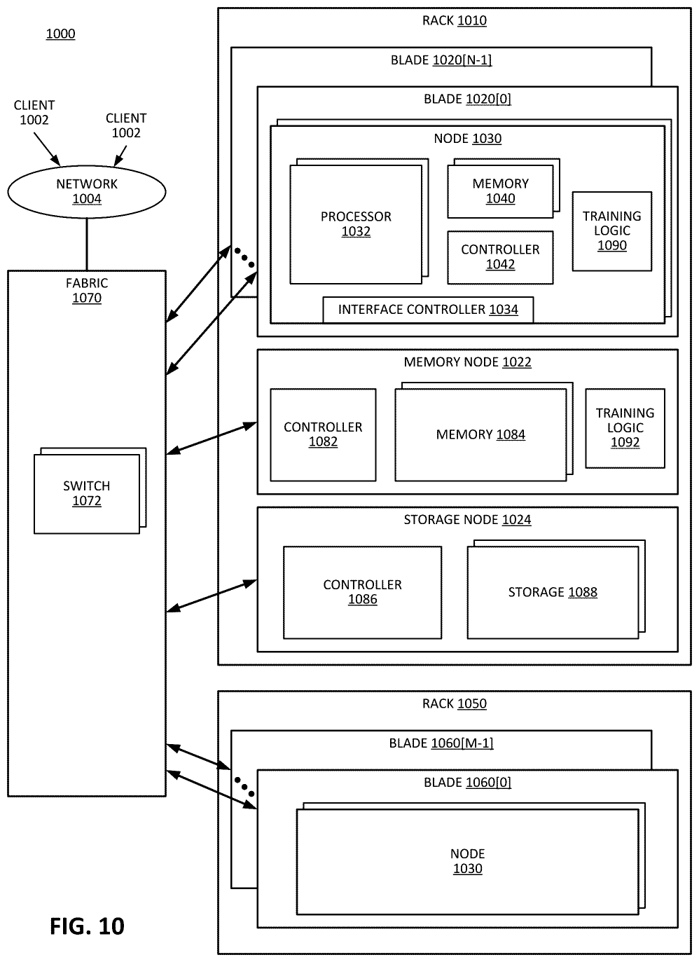

FIG. 10 is a block diagram of an example of a multi-node network in which autonomous training sweeps can be implemented. System 1000 represents a network of nodes that can apply adaptive ECC. In one example, system 1000 represents a data center. In one example, system 1000 represents a server farm. In one example, system 1000 represents a data cloud or a processing cloud.

System 1000 represents a system with memory subsystems in accordance with an example of system 100, an example of system 200, an example of system 302, and example of system 304, or an example of system 400.

In one example, node 1030 includes training logic 1090. Training logic 1090 represents in-built logic in memory 1040 and logic in controller 1042. With training logic 1090, controller 1042 knows that memory 1040 is enabled to internally perform parameter sweeps, and thus, will only send a command to initiate the training mode, and it will send the training pattern traffic, but will allow the memory to internally handle parameter sweeps. With training logic 1090, memory 1040 is enabled to internally perform parameter sweeps for I/O training. The internal sweeping can be in accordance with any example herein. In one example, memory node 1022 also includes training logic 1092. Training logic 1092 provides for memory 1084 and controller 1082 what training logic 1090 provides for memory 1040 and controller 1042, respectively.

One or more clients 1002 make requests over network 1004 to system 1000. Network 1004 represents one or more local networks, or wide area networks, or a combination. Clients 1002 can be human or machine clients, which generate requests for the execution of operations by system 1000. System 1000 executes applications or data computation tasks requested by clients 1002.

In one example, system 1000 includes one or more racks, which represent structural and interconnect resources to house and interconnect multiple computation nodes. In one example, rack 1010 includes multiple nodes 1030. In one example, rack 1010 hosts multiple blade components, blade 1020[0], . . . , blade 1020[N−1], collectively blades 1020. Hosting refers to providing power, structural or mechanical support, and interconnection. Blades 1020 can refer to computing resources on printed circuit boards (PCBs), where a PCB houses the hardware components for one or more nodes 1030. In one example, blades 1020 do not include a chassis or housing or other “box” other than that provided by rack 1010. In one example, blades 1020 include housing with exposed connector to connect into rack 1010. In one example, system 1000 does not include rack 1010, and each blade 1020 includes a chassis or housing that can stack or otherwise reside in close proximity to other blades and allow interconnection of nodes 1030.

System 1000 includes fabric 1070, which represents one or more interconnectors for nodes 1030. In one example, fabric 1070 includes multiple switches 1072 or routers or other hardware to route signals among nodes 1030. Additionally, fabric 1070 can couple system 1000 to network 1004 for access by clients 1002. In addition to routing equipment, fabric 1070 can be considered to include the cables or ports or other hardware equipment to couple nodes 1030 together. In one example, fabric 1070 has one or more associated protocols to manage the routing of signals through system 1000. In one example, the protocol or protocols is at least partly dependent on the hardware equipment used in system 1000.

As illustrated, rack 1010 includes N blades 1020. In one example, in addition to rack 1010, system 1000 includes rack 1050. As illustrated, rack 1050 includes M blade components, blade 1060[0], . . . , blade 1060[M−1], collectively blades 1060. M is not necessarily the same as N; thus, it will be understood that various different hardware equipment components could be used, and coupled together into system 1000 over fabric 1070. Blades 1060 can be the same or similar to blades 1020. Nodes 1030 can be any type of node and are not necessarily all the same type of node. System 1000 is not limited to being homogenous, nor is it limited to not being homogenous.

The nodes in system 1000 can include compute nodes, memory nodes, storage nodes, accelerator nodes, or other nodes. Rack 1010 is represented with memory node 1022 and storage node 1024, which represent shared system memory resources, and shared persistent storage, respectively. One or more nodes of rack 1050 can be a memory node or a storage node.

Nodes 1030 represent examples of compute nodes. For simplicity, only the compute node in blade 1020[0] is illustrated in detail. However, other nodes in system 1000 can be the same or similar. At least some nodes 1030 are computation nodes, with processor (proc) 1032 and memory 1040. A computation node refers to a node with processing resources (e.g., one or more processors) that executes an operating system and can receive and process one or more tasks. In one example, at least some nodes 1030 are server nodes with a server as processing resources represented by processor 1032 and memory 1040.

Memory node 1022 represents an example of a memory node, with system memory external to the compute nodes. Memory nodes can include controller 1082, which represents a processor on the node to manage access to the memory. The memory nodes include memory 1084 as memory resources to be shared among multiple compute nodes.

Storage node 1024 represents an example of a storage server, which refers to a node with more storage resources than a computation node, and rather than having processors for the execution of tasks, a storage server includes processing resources to manage access to the storage nodes within the storage server. Storage nodes can include controller 1086 to manage access to the storage 1088 of the storage node.

In one example, node 1030 includes interface controller 1034, which represents logic to control access by node 1030 to fabric 1070. The logic can include hardware resources to interconnect to the physical interconnection hardware. The logic can include software or firmware logic to manage the interconnection. In one example, interface controller 1034 is or includes a host fabric interface, which can be a fabric interface in accordance with any example described herein. The interface controllers for memory node 1022 and storage node 1024 are not explicitly shown.

Processor 1032 can include one or more separate processors. Each separate processor can include a single processing unit, a multicore processing unit, or a combination. The processing unit can be a primary processor such as a CPU (central processing unit), a peripheral processor such as a GPU (graphics processing unit), or a combination. Memory 1040 can be or include memory devices represented by memory 1040 and a memory controller represented by controller 1042.

In general with respect to the descriptions herein, in one aspect a first memory device includes: a physical interface to couple to a memory controller; and a configuration register to store a first value for a first configuration parameter for the physical interface and a second value for a second configuration parameter for the physical interface; wherein the physical interface is to receive a command to trigger a training mode to sweep the first configuration parameter, and to autonomously sweep the second configuration parameter during sweep of the first configuration parameter in the training mode.

In one example of the first memory device, the physical interface comprises an interface to a command and address (CA) bus. In accordance with any preceding example of the first memory device, in one example, the first configuration parameter comprises a delay setting and wherein the second configuration parameter comprises a voltage reference setting. In accordance with any preceding example of the first memory device, in one example, the first configuration parameter and the second configuration parameter each comprises a different parameter selected from: a voltage reference setting, a delay setting, a DFE (decision feedback equalization) setting, or a termination offset. In accordance with any preceding example of the first memory device, in one example, the command to trigger the training mode comprises a multipurpose command (MPC). In accordance with any preceding example of the first memory device, in one example, in the training mode, the memory controller is to send data patterns with read and write commands, and wherein the memory device includes logic to count a number of chip selects from the read and write commands, to manage transition for the autonomous sweep of the second configuration parameter in the training mode. In accordance with any preceding example of the first memory device, in one example, the physical interface comprises an interface to a data (DQ) bus. In accordance with any preceding example of the first memory device, in one example, the first memory device includes: a linear feedback shift register (LFSR) to manage the sweep of the second configuration parameter for an interface to the DQ bus. In accordance with any preceding example of the first memory device, in one example, the LFSR comprises an LFSR per DQ of the physical interface. In accordance with any preceding example of the first memory device, in one example, the physical interface comprises an interface to a data strobe (DQS). In accordance with any preceding example of the first memory device, in one example, the memory controller is to send an indication of when the sweep of the first configuration parameter is complete. In accordance with any preceding example of the first memory device, in one example, the memory controller is to set a bit in a mode register to send the indication.

In general with respect to the descriptions herein, in one aspect a first computer system includes: a memory controller; and a memory chip including: a physical interface to couple to the memory controller; and a configuration register to store a first value for a first configuration parameter for the physical interface and a second value for a second configuration parameter for the physical interface; wherein the physical interface is to receive a command to trigger a training mode to sweep the first configuration parameter, and to autonomously sweep the second configuration parameter during sweep of the first configuration parameter in the training mode.

In one example of the first computer system, the physical interface comprises an interface to a command and address (CA) bus. In accordance with any preceding example of the first computer system, in one example, the first configuration parameter comprises a delay setting and wherein the second configuration parameter comprises a voltage reference setting. In accordance with any preceding example of the first computer system, in one example, the first configuration parameter and the second configuration parameter each comprises a different parameter selected from: a voltage reference setting, a delay setting, a DFE (decision feedback equalization) setting, or a termination offset. In accordance with any preceding example of the first computer system, in one example, the command to trigger the training mode comprises a multipurpose command (MPC). In accordance with any preceding example of the first computer system, in one example, in the training mode, the memory controller is to send data patterns with read and write commands, and wherein the memory chip includes logic to count a number of chip selects from the read and write commands, to manage transition for the autonomous sweep of the second configuration parameter in the training mode. In accordance with any preceding example of the first computer system, in one example, the physical interface comprises an interface to a data (DQ) bus. In accordance with any preceding example of the first computer system, in one example, the memory chip includes: a linear feedback shift register (LFSR) to manage the sweep of the second configuration parameter for an interface to the DQ bus. In accordance with any preceding example of the first computer system, in one example, the LFSR comprises an LFSR per DQ of the physical interface. In accordance with any preceding example of the first computer system, in one example, the memory controller is to send an indication of when the sweep of the first configuration parameter is complete over a sideband bus separate from a command and address (CA) bus and from a data (DQ) bus. In accordance with any preceding example of the first computer system, in one example, the physical interface comprises an interface to a data strobe (DQS). In accordance with any preceding example of the first computer system, in one example, the memory controller is to send an indication of when the sweep of the first configuration parameter is complete. In accordance with any preceding example of the first computer system, in one example, the memory controller is to set a bit in a mode register to send the indication. In accordance with any preceding example of the first computer system, in one example, the first computer system includes a multicore processor device coupled to the memory controller. In accordance with any preceding example of the first computer system, in one example, the first computer system includes a display communicatively coupled to a processor device. In accordance with any preceding example of the first computer system, in one example, the first computer system includes a battery to power the system. In accordance with any preceding example of the first computer system, in one example, the first computer system includes a network interface circuit to couple with a remote device over a network connection.

In general with respect to the descriptions herein, in one aspect a first method for setting a configuration includes: coupling to a memory controller through a physical interface; and storing in a configuration register a first value for a first configuration parameter for the physical interface; storing in the configuration register a second value for a second configuration parameter for the physical interface; receiving a command to trigger a training mode to sweep the first configuration parameter; and autonomously sweeping the second configuration parameter during sweep of the first configuration parameter in the training mode.

In one example of the first method, coupling to the memory controller through the physical interface comprises coupling to a command and address (CA) bus. In accordance with any preceding example of the first method, in one example, the first configuration parameter comprises a delay setting and wherein the second configuration parameter comprises a voltage reference setting. In accordance with any preceding example of the first method, in one example, the first configuration parameter and the second configuration parameter each comprises a different parameter selected from: a voltage reference setting, a delay setting, a DFE (decision feedback equalization) setting, or a termination offset. In accordance with any preceding example of the first method, in one example, the command to trigger the training mode comprises a multipurpose command (MPC). In accordance with any preceding example of the first method, in one example, in the training mode, the memory controller is to send data patterns with read and write commands, wherein the first method includes counting a number of chip selects from the read and write commands, to manage transition for the autonomous sweep of the second configuration parameter in the training mode. In accordance with any preceding example of the first method, in one example, coupling to the memory controller through the physical interface comprises coupling an interface to a data (DQ) bus. In accordance with any preceding example of the first method, in one example, the first method includes managing the sweep of the second configuration parameter for an interface to the DQ bus with a linear feedback shift register (LFSR). In accordance with any preceding example of the first method, in one example, the LFSR comprises an LFSR per DQ of the physical interface. In accordance with any preceding example of the first method, in one example, coupling to the memory controller through the physical interface comprises coupling an interface to a data strobe (DQS). In accordance with any preceding example of the first method, in one example, the method further includes receiving an indication from the memory controller of when the sweep of the first configuration parameter is complete. In accordance with any preceding example of the first method, in one example, receiving the indication comprises the memory controller setting a bit in a mode register.

In general with respect to the descriptions herein, in one aspect a second memory device includes: a physical interface to couple to a memory controller; and a configuration register to store a value for a configuration parameter for the physical interface; wherein the physical interface is to receive a command to trigger a training mode to sweep the configuration parameter, wherein the memory device is to autonomously sweep the configuration parameter in the training mode without a command from the memory controller indicating a new value for the sweep of the configuration parameter.

In one example of the second memory device, the physical interface comprises an interface to a command and address (CA) bus. In accordance with any preceding example of the second memory device, in one example, the configuration parameter comprises a voltage reference setting. In accordance with any preceding example of the second memory device, in one example, the configuration parameter comprises a delay setting. In accordance with any preceding example of the second memory device, in one example, the configuration parameter comprises a DFE (decision feedback equalization) setting. In accordance with any preceding example of the second memory device, in one example, the configuration parameter comprises a termination offset. In accordance with any preceding example of the second memory device, in one example, the configuration parameter comprises a data strobe offset setting. In accordance with any preceding example of the second memory device, in one example, the configuration parameter comprises a write-leveling cycle alignment setting. In accordance with any preceding example of the second memory device, in one example, the command to trigger the training mode comprises a multipurpose command (MPC). In accordance with any preceding example of the second memory device, in one example, in the training mode, the memory controller is to send data patterns with read and write commands, and wherein the memory device includes logic to count a number of chip selects from the read and write commands, to manage transition for the autonomous sweep of the configuration parameter in the training mode. In accordance with any preceding example of the second memory device, in one example, the physical interface comprises an interface to a data (DQ) bus. In accordance with any preceding example of the second memory device, in one example, the second memory device includes: a linear feedback shift register (LFSR) to manage the sweep of the configuration parameter for an interface to the DQ bus. In accordance with any preceding example of the second memory device, in one example, the LFSR comprises an LFSR per DQ of the physical interface. In accordance with any preceding example of the second memory device, in one example, the physical interface comprises an interface to a data strobe (DQS). In accordance with any preceding example of the second memory device, in one example, the memory controller is to send an indication of when the sweep of the configuration parameter is complete. In accordance with any preceding example of the second memory device, in one example, the memory controller is to set a bit in a mode register to send the indication.

In general with respect to the descriptions herein, in one aspect a second computer system includes: a memory controller; and a memory chip including: a physical interface to couple to a memory controller; and a configuration register to store a value for a configuration parameter for the physical interface; wherein the physical interface is to receive a command to trigger a training mode to sweep the configuration parameter, wherein the memory device is to autonomously sweep the configuration parameter in the training mode without a command from the memory controller indicating a new value for the sweep of the configuration parameter.

In one example of the second computer system, the physical interface comprises an interface to a command and address (CA) bus. In accordance with any preceding example of the second computer system, in one example, the configuration parameter comprises a voltage reference setting. In accordance with any preceding example of the second computer system, in one example, the configuration parameter comprises a delay setting. In accordance with any preceding example of the second computer system, in one example, the configuration parameter comprises a DFE (decision feedback equalization) setting. In accordance with any preceding example of the second computer system, in one example, the configuration parameter comprises a termination offset. In accordance with any preceding example of the second computer system, in one example, the configuration parameter comprises a data strobe offset setting. In accordance with any preceding example of the second computer system, in one example, the configuration parameter comprises a write-leveling cycle alignment setting. In accordance with any preceding example of the second computer system, in one example, the command to trigger the training mode comprises a multipurpose command (MPC). In accordance with any preceding example of the second computer system, in one example, in the training mode, the memory controller is to send data patterns with read and write commands, and wherein the memory chip includes logic to count a number of chip selects from the read and write commands, to manage transition for the autonomous sweep of the configuration parameter in the training mode. In accordance with any preceding example of the second computer system, in one example, the physical interface comprises an interface to a data (DQ) bus. In accordance with any preceding example of the second computer system, in one example, the memory chip includes: a linear feedback shift register (LFSR) to manage the sweep of the configuration parameter for an interface to the DQ bus. In accordance with any preceding example of the second computer system, in one example, the LFSR comprises an LFSR per DQ of the physical interface. In accordance with any preceding example of the second computer system, in one example, the memory controller is to send an indication of when the sweep of the configuration parameter is complete over a sideband bus separate from a command and address (CA) bus and from a data (DQ) bus. In accordance with any preceding example of the second computer system, in one example, the physical interface comprises an interface to a data strobe (DQS). In accordance with any preceding example of the second computer system, in one example, the memory controller is to send an indication of when the sweep of the configuration parameter is complete. In accordance with any preceding example of the second computer system, in one example, the memory controller is to set a bit in a mode register to send the indication. In accordance with any preceding example of the second computer system, in one example, the second computer system includes a multicore processor device coupled to the memory controller. In accordance with any preceding example of the second computer system, in one example, the second computer system includes a display communicatively coupled to a processor device. In accordance with any preceding example of the second computer system, in one example, the second computer system includes a battery to power the system. In accordance with any preceding example of the second computer system, in one example, the second computer system includes a network interface circuit to couple with a remote device over a network connection.

In general with respect to the descriptions herein, in one aspect a second method for setting a configuration includes: coupling to a memory controller through a physical interface; storing in a configuration register a value for a configuration parameter for the physical interface; receiving a command to trigger a training mode to sweep the configuration parameter; and autonomously sweeping the configuration parameter in the training mode without a command from the memory controller indicating a new value for the sweep of the configuration parameter.

In one example of the second method, coupling to the memory controller through the physical interface comprises coupling to a command and address (CA) bus. In accordance with any preceding example of the second method, in one example, the configuration parameter comprises a voltage reference setting. In accordance with any preceding example of the second method, in one example, the configuration parameter comprises a delay setting. In accordance with any preceding example of the second method, in one example, the configuration parameter comprises a DFE (decision feedback equalization) setting. In accordance with any preceding example of the second method, in one example, the configuration parameter comprises a termination offset. In accordance with any preceding example of the second method, in one example, the configuration parameter comprises a data strobe offset setting. In accordance with any preceding example of the second method, in one example, the configuration parameter comprises a write-leveling cycle alignment setting. In accordance with any preceding example of the second method, in one example, the command to trigger the training mode comprises a multipurpose command (MPC). In accordance with any preceding example of the second method, in one example, in the training mode, the memory controller is to send data patterns with read and write commands, wherein the first method includes counting a number of chip selects from the read and write commands, to manage transition for the autonomous sweep of the configuration parameter in the training mode. In accordance with any preceding example of the second method, in one example, coupling to the memory controller through the physical interface comprises coupling an interface to a data (DQ) bus. In accordance with any preceding example of the second method, in one example, the second method includes managing the sweep of the configuration parameter for an interface to the DQ bus with a linear feedback shift register (LFSR). In accordance with any preceding example of the second method, in one example, the LFSR comprises an LFSR per DQ of the physical interface. In accordance with any preceding example of the second method, in one example, coupling to the memory controller through the physical interface comprises coupling an interface to a data strobe (DQS). In accordance with any preceding example of the second method, in one example, the method further includes receiving an indication from the memory controller of when the sweep of the configuration parameter is complete. In accordance with any preceding example of the second method, in one example, receiving the indication comprises the memory controller setting a bit in a mode register.

Flow diagrams as illustrated herein provide examples of sequences of various process actions. The flow diagrams can indicate operations to be executed by a software or firmware routine, as well as physical operations. A flow diagram can illustrate an example of the implementation of states of a finite state machine (FSM), which can be implemented in hardware and/or software. Although shown in a particular sequence or order, unless otherwise specified, the order of the actions can be modified. Thus, the illustrated diagrams should be understood only as examples, and the process can be performed in a different order, and some actions can be performed in parallel. Additionally, one or more actions can be omitted; thus, not all implementations will perform all actions.

To the extent various operations or functions are described herein, they can be described or defined as software code, instructions, configuration, and/or data. The content can be directly executable (“object” or “executable” form), source code, or difference code (“delta” or “patch” code). The software content of what is described herein can be provided via an article of manufacture with the content stored thereon, or via a method of operating a communication interface to send data via the communication interface. A machine readable storage medium can cause a machine to perform the functions or operations described, and includes any mechanism that stores information in a form accessible by a machine (e.g., computing device, electronic system, etc.), such as recordable/non-recordable media (e.g., read only memory (ROM), random access memory (RAM), magnetic disk storage media, optical storage media, flash memory devices, etc.). A communication interface includes any mechanism that interfaces to any of a hardwired, wireless, optical, etc., medium to communicate to another device, such as a memory bus interface, a processor bus interface, an Internet connection, a disk controller, etc. The communication interface can be configured by providing configuration parameters and/or sending signals to prepare the communication interface to provide a data signal describing the software content. The communication interface can be accessed via one or more commands or signals sent to the communication interface.

Various components described herein can be a means for performing the operations or functions described. Each component described herein includes software, hardware, or a combination of these. The components can be implemented as software modules, hardware modules, special-purpose hardware (e.g., application specific hardware, application specific integrated circuits (ASICs), digital signal processors (DSPs), etc.), embedded controllers, hardwired circuitry, etc.

Besides what is described herein, various modifications can be made to what is disclosed and implementations of the invention without departing from their scope. Therefore, the illustrations and examples herein should be construed in an illustrative, and not a restrictive sense. The scope of the invention should be measured solely by reference to the claims that follow.

What is claimed is:

1. A memory device comprising:
a physical interface to couple to a memory controller; and
a configuration register to store a first value for a first configuration parameter for the physical interface and a second value for a second configuration parameter for the physical interface;
wherein the physical interface is to receive a command to trigger a training mode to sweep the first configuration parameter, and to autonomously sweep the second configuration parameter during sweep of the first configuration parameter in the training mode.

2. The memory device of claim 1, wherein the physical interface comprises an interface to a command and address (CA) bus.

3. The memory device of claim 1, wherein the first configuration parameter comprises a delay setting and wherein the second configuration parameter comprises a voltage reference setting.

4. The memory device of claim 1, wherein the command to trigger the training mode comprises a multipurpose command (MPC).

5. The memory device of claim 1, wherein in the training mode, the memory controller is to send data patterns with read and write commands, and wherein the memory device includes logic to count a number of chip selects from the read and write commands, to manage transition for the autonomous sweep of the second configuration parameter in the training mode.

6. The memory device of claim 1, wherein the physical interface comprises an interface to a data (DQ) bus.

7. The memory device of claim 6, further comprising:
a linear feedback shift register (LFSR) to manage the sweep of the second configuration parameter for an interface to the DQ bus.

8. The memory device of claim 7, wherein the LFSR comprises an LFSR per DQ of the physical interface.

9. The memory device of claim 1, wherein the physical interface comprises an interface to a data strobe (DQS).

10. The memory device of claim 1, wherein the memory controller is to send an indication of when the sweep of the first configuration parameter is complete.

11. The memory device of claim 10, wherein the memory controller is to set a bit in a mode register to send the indication.

12. A computer system comprising:
a memory controller; and
a memory chip including:
a physical interface to couple to the memory controller; and
a configuration register to store a first value for a first configuration parameter for the physical interface and a second value for a second configuration parameter for the physical interface;
wherein the physical interface is to receive a command to trigger a training mode to sweep the first configuration parameter, and to autonomously sweep the second configuration parameter during sweep of the first configuration parameter in the training mode.

13. The computer system of claim 12, wherein the physical interface comprises an interface to a command and address (CA) bus.

14. The computer system of claim 12, wherein the first configuration parameter comprises a delay setting and wherein the second configuration parameter comprises a voltage reference setting.

15. The computer system of claim 12, wherein in the training mode, the memory controller is to send data patterns with read and write commands, and wherein the memory chip includes logic to count a number of chip selects from the read and write commands, to manage transition for the autonomous sweep of the second configuration parameter in the training mode.

16. The computer system of claim 12, wherein the physical interface comprises an interface to a data (DQ) bus.

17. The computer system of claim 16, the memory chip further comprises:
a linear feedback shift register (LFSR) to manage the sweep of the second configuration parameter for an interface to the DQ bus.

18. The computer system of claim 17, wherein the LFSR comprises an LFSR per DQ of the physical interface.

19. The computer system of claim 12, wherein the memory controller is to send an indication of when the sweep of the first configuration parameter is complete over a sideband bus separate from a command and address (CA) bus and from a data (DQ) bus.

20. The computer system of claim 12, further comprising:
a multicore processor device coupled to the memory controller;
a display communicatively coupled to a processor device;
a battery to power the system; or
a network interface circuit to couple with a remote device over a network connection.
